(19) United States
(12) Patent Application Publication
(10) Pub. No.: US 2006/0193140 A1
(43) Pub. Date: Aug. 31, 2006

(54) Lamp assembly, backlight assembly and display apparatus having the same

(76) Inventor: Jun-Woo You, Yongin-si (KR)

Correspondence Address: MacPherson Kwok Chen & Heid LLP, 1762 Technology Drive, Suite 226, San Jose, CA, 95110, US

(21) Appl. No.: 11/347,518

(22) Filed: Feb. 3, 2006

(30) Foreign Application Priority Data
Feb. 3, 2005 (KR) 2005-10073

(51) Int. Cl. F21V 19/00

(52) U.S. Cl. 362/382

(57) ABSTRACT

In a lamp assembly, a backlight assembly and a display apparatus, a wire unit receives a driving signal and a lamp unit emits a light in response to the driving signal. The wire unit and the lamp unit are each attached with a holder unit. The holder unit has a holder portion coupled with the lamp unit and the wire unit and a socket portion electrically connecting the lamp unit with the wire unit.

### CROSS-REFERENCE TO RELATED APPLICATIONS

This application claims priority to and the benefit of Korean Patent Application No. 2005-10073 filed on Feb. 3, 2005, which is hereby incorporated by reference for all purposes as if fully set forth herein.

### BACKGROUND OF THE INVENTION

1. Field of the Invention

The present invention relates to a lamp assembly, a backlight assembly, and a display apparatus. More particularly, the present invention relates to a lamp assembly having a simplified assembly process, a backlight assembly having the lamp assembly and a display apparatus having the backlight assembly.

2. Description of the Related Art

A liquid crystal display apparatus includes a liquid crystal display panel that displays an image and a backlight assembly that supplies a light to the liquid crystal display apparatus.

The backlight assembly includes a lamp unit that emits the light in response to a driving signal, a light guide plate that guides the light to the liquid crystal display panel and a mold frame that receives the lamp unit and the light guide plate.

The light guide plate typically has a rectangular plate-like shape. The light guide plate changes a path of the light incident through a side face thereof and supplies the light to the liquid crystal display panel through an upper face thereof facing the liquid crystal display panel.

The lamp unit includes a lamp body that emits the light in response to the driving signal and an electrode that receives the driving signal. The electrode extends from the lamp body. The electrode is electrically connected with a wire to receive the driving signal. The electrode may be soldered to an insulated conductor wire of the wire. The lamp unit further includes a lamp holder to protect the soldered portion between the electrode and the insulated conductor wire when an external impact is applied to the soldered portion or the wire is moved.

However, since the lamp holder is assembled with the lamp body after the electrode is soldered to the insulated conductor wire, an assembling process for the backlight assembly is complex. The soldered portion between the electrode and the insulated conductor wire of the wire breaks or damages due to stresses occurring while the lamp holder is coupled with the lamp body and the wire.

### SUMMARY OF THE INVENTION

The present invention provides a lamp assembly capable of simplifying an assembly process thereof, Additional features of the invention will be set forth in the description which follows, and in part will be apparent from the description, or may be learned by practice of the invention.

The present invention discloses a lamp assembly, including a wire unit to output a driving signal, a lamp unit to emit a light in response to the driving signal, and a holder unit including a holder portion, which is coupled with the lamp unit and the wire unit, and a socket portion, which is provided in the holder portion to electrically connect the lamp unit with the wire unit.

The present invention also discloses a lamp assembly including a first wire unit including a first wire to receive a first driving signal and a first socket coupled with an end of the first wire to receive the first driving signal, a second wire unit including a second wire, which receives a second driving signal, and a second socket coupled with an end of the second wire to receive the second driving signal, a lamp unit including a lamp body, a first electrode connected with a first end of the lamp body to receive the first driving signal, and a second electrode connected with a second end of the lamp body to receive the second driving signal, a first holder unit including a first holder portion coupled with the first end of the lamp body, a second holder portion coupled with an end of the first wire and integrally formed with the first holder portion, and a first socket portion electrically connecting the first wire with the first socket to apply the first driving signal to the first socket, and a second holder unit having a third holder portion coupled with the second end of the lamp body, a fourth holder portion coupled with an end of the second wire and integrally formed with the third holder portion, and a second socket portion electrically connecting the second wire with the second socket to apply the second driving signal wire to the second socket.

The present invention also discloses a backlight assembly including a lamp assembly to generate a light in response to a driving signal, a light guide plate to receive the light and guide the received light, and a receiving member to receive the lamp assembly and the light guide plate, wherein the lamp assembly includes a first wire unit to output a first driving signal, a second wire unit to output a second driving signal, a lamp unit including a lamp body, a first electrode and a second electrode extending from a first end and a second end of the lamp body, respectively, to receive a first driving signal and a second driving signal, a first holder unit including a first holder portion coupled with the first end of the lamp body, a second holder portion coupled to the first wire unit and integrally formed with the first holder portion, and a first socket portion formed in the first holder portion to electrically connect the first electrode with the first wire unit, and a second holder unit including a third holder portion coupled with a second end of the lamp body, a fourth holder portion coupled with the second wire unit and integrally formed with the third holder portion, and a second socket portion formed in the third holder portion to couple the second electrode with the second wire unit.

The present invention also discloses a display apparatus including a backlight assembly to generate a light, a display panel to display an image using the light, wherein the backlight assembly includes a lamp assembly to generate a light in response to a driving signal, a light guide plate to receive the light and guide the received light, and a receiving member to receive the lamp assembly and the light guide plate, the lamp assembly includes a first wire unit to output a first driving signal, a second wire unit to output a second driving signal, a lamp unit having a lamp body, a first electrode and a second electrode extending from a first end and a second end of the lamp body, respectively, to receive a first driving signal and a second driving signal, a first holder unit having a first holder portion coupled with a first end of the lamp body, a second holder portion coupled with the first wire unit and integrally formed with the first holder portion, and a first socket portion formed in the first holder portion to electrically connect the first electrode with the first wire unit, and a second holder unit having a third holder portion coupled with a second end of the lamp body, a fourth holder portion coupled with the second wire unit and integrally formed with the third holder portion, and a second socket portion formed in the third holder portion to electrically connect the second electrode with the second wire unit.

It is to be understood that both the foregoing general description and the following detailed description are exemplary and explanatory and are intended to provide further explanation of the invention as claimed.

a backlight assembly having the above lamp assembly, a display apparatus having the above the backlight assembly.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. FIG. 1 is an exploded perspective view showing a lamp assembly according to an embodiment of the invention.

FIG. 2 is a cross-sectional view showing a first wire unit in FIG. 1.

FIG. 3 is a cross-sectional view taken along a line I-I′ showing a first holder unit in FIG. 1.

FIG. 4 is a perspective view showing the lamp assembly in FIG. 1.

FIG. 5 is a cross-sectional view taken along a line II-II′ showing the lamp assembly in FIG. 4.

FIG. 6 is an exploded perspective view showing a backlight assembly according to an exemplary embodiment of the invention.

FIG. 7 is a cross-sectional view taken along a line III-III′ showing the backlight assembly in FIG. 6.

FIG. 8 is an exploded perspective view showing a liquid crystal display apparatus according to an embodiment of the invention.

FIG. 9 is a cross-sectional view taken along a lint IV-IV′ showing the liquid crystal display apparatus in FIG. 8.

### DESCRIPTION OF THE EMBODIMENTS

The present invention is explained below with reference to the accompanying drawings.

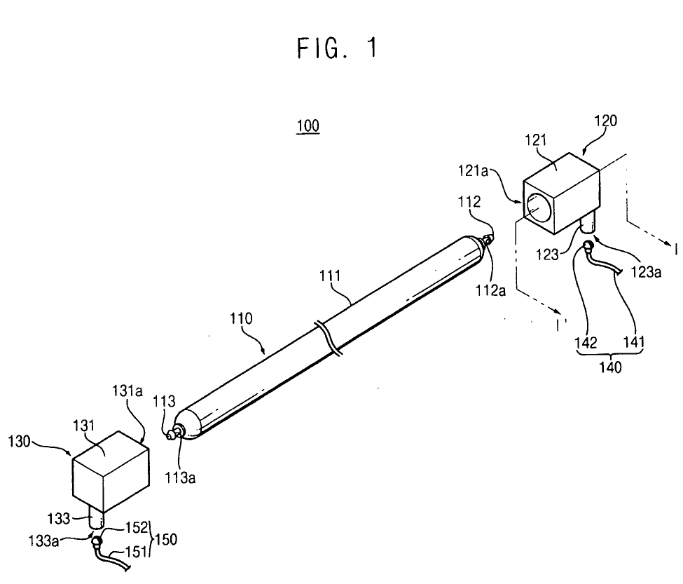

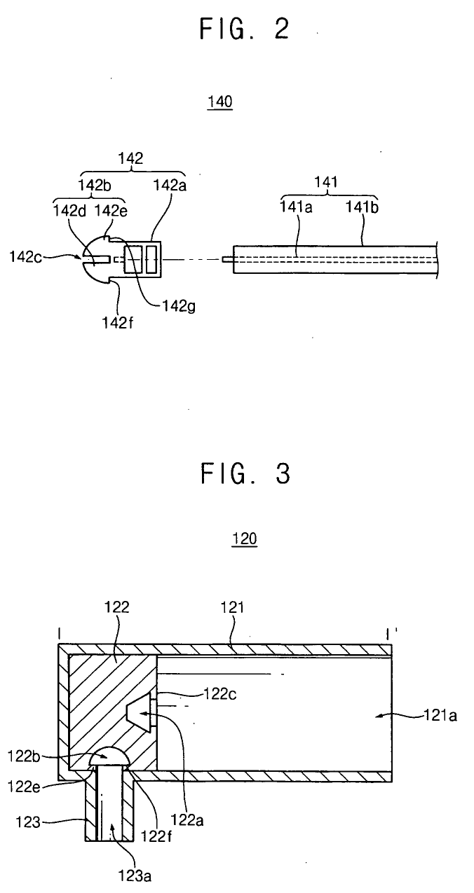

FIG. 1 is an exploded perspective view showing a lamp assembly according to an embodiment of the invention. FIG. 2 is a cross-sectional view showing a first wire unit in FIG. 1. FIG. 3 is a cross-sectional view taken along a line I-I′ showing a first holder unit in FIG. 1.

Referring to FIG. 1, a lamp assembly 100 includes a lamp unit 110, a first holder unit 120, a second holder unit 130, a first wire unit 140 and a second wire unit 150.

The lamp unit 110 includes a lamp body 111, a first electrode 112, and a second electrode 113. The lamp body 111 may be a cold cathode fluorescent lamp and may have a generally tubular shape. It is understood that the lamp body 111 may have various shapes and is not limited to the shape shown in FIG. 1.

The first electrode 112 and the second electrode 113 are withdrawn from first and second ends of the lamp body 111, respectively. The first electrode 112 and the second electrode 113 receive first and second driving voltages, respectively. The lamp body 111 emits a light in response to the first and second driving voltages applied thereto through the first electrode 112 and the second electrode 113.

The first electrode 112 may have a first coupling jaw 112a allowing the first electrode to be coupled with the first holder unit 120. The second electrode 113 may have a second coupling jaw 113a allowing the second electrode 113 to be coupled with the second holder unit 130;

The first holder unit 120 may include a first receiving recess 121a that receives a first end of the lamp body 111. The second holder unit 130 may include a second receiving recess 131 a that receives a second end of the lamp body 111.

The first holder unit 120 may further include a third receiving recess 123a that receives an end portion of the first wire unit 140. The second holder unit 130 may further include a fourth receiving recess 133a that receives an end portion of the second wire unit 150.

The first wire unit 140 includes a first wire 141 and may include a first socket 142 coupled with an end of the first wire 141. The second wire unit 150 includes a second wire 151 and may include a second socket 152 coupled with an end of the second wire 151. The first socket 142 is received into the third receiving recess 123a allowing the first socket 142 to be coupled to the first holder unit 120. The second socket 152 is received into the fourth receiving recess 133a allowing the second socket 152 to be coupled to the second holder unit 130.

As shown in FIG. 2, the first wire 141 may have an insulated conductor wire 141a and a protective coating 141b. The insulated conductor wire 141a may include a conductive material and receives the first driving voltage to drive the lamp 110. The protective coating 141b may include an insulating material to protect the insulated conductor wire 141a.

The first socket 142 may include a receiving portion 142a that receives an end of the first wire 141 and a protruding portion 142b that is inserted into a second engaging recess 122b of a socket portion 122. The insulated conductor wire 141a may be exposed at the end of the first wire 141 so that the exposed insulated conductor wire 141a is electrically connected with the first socket 142. The first driving voltage applied to the insulated conductor wire 141a may then be transmitted to the first socket 142.

The protruding portion 142b includes a first protrusion 142d and a second protrusion 142e, which are spaced apart from each other by a space 142c. The first protrusion 142d faces the second protrusion 142e. The first protrusion 142d and the second protrusion 142e may be integrally formed with the receiving portion 142a to form a third coupling jaw 142f and a fourth coupling jaw 142g between the receiving portion 142a and the protruding portion 142b. The third coupling jaw 142f and the fourth coupling jaw 142g allow the first socket 142 to be coupled to the first holder unit 120.

In FIG. 2, the first wire unit 140 has been described in detail, however detailed description of the second wire unit 150 will be omitted since the second wire unit 150 has the same function and structure as the first wire unit 140.

As shown in FIG. 3, the first holder unit 120 includes a first holder portion 121, a second holder portion 123, and a socket portion 122. The first holder unit 121 may have a rectangular pipe-like shape in cross sectional profile having a closed first end and an opened second end that is opposite to the first end. The first holder unit 121 may include the first receiving recess 121 a to receive the first end of the lamp body 111. It is understood that the shape of the first holder unit 121 may take various shapes.

The second holder unit 123 may have a cylindrical like shape and may be integrally formed with the first holder unit 121. The second holder unit 123 includes the third receiving recess 123a to receive the end portion of the first wire unit 150. The first holder unit 121 and the second holder unit 123 each may include an insulation material and is formed by an injection molding technique.

The socket portion 122 may include a conductor material and is formed in the first holder unit 121. The socket portion 122 may be simultaneously formed with the first holder unit 121 and the second holder unit 123 by injection molding so that the socket portion 122 is held or provided in the first holder unit 121.

The socket portion 122 includes a first engaging recess 122a adjacent to the first receiving recess 121a and a second engaging recess 122b adjacent to the third receiving recess 123a. The first engaging recess 122a is engaged or connected with the first electrode 112 of the lamp 110. The first engaging recess 122a is provided with a first coupling protrusion 122c coupled with the first coupling jaw 112a of the first electrode 112.

The second engaging recess 122b is engaged or connected with the first socket 142 of the first wire unit 140. The second engaging recess 122b is provided with a second protrusion 122e and a third coupling protrusion 122f, respectively coupled to the third coupling jaw 142f and the fourth coupling jaw 142g of the first socket 142.

A detailed description of the second holder unit 130 is omitted for purposes of convenience since the second holder unit 130 has same function and structure as the first holder unit 120.

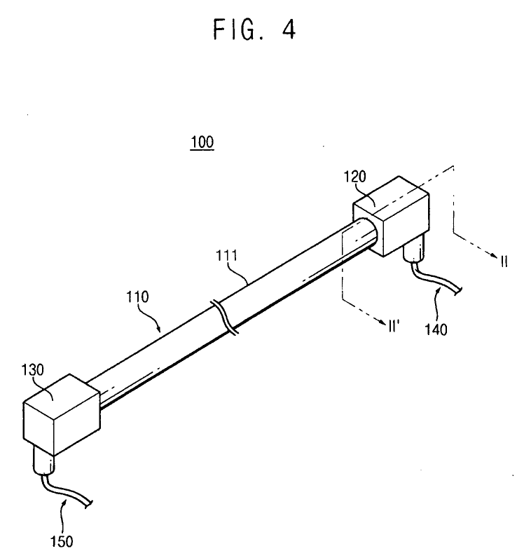

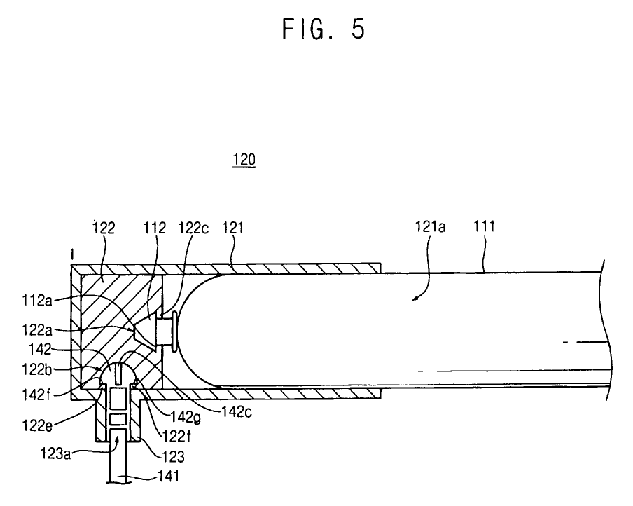

FIG. 4 is a perspective view showing the lamp assembly in FIG. 1. FIG. 5 is a cross-sectional view taken along a line II-II′ showing the lamp assembly in FIG. 4.

Referring to FIG. 4 and FIG. 5, the first end of the lamp body 111 is received in the first receiving recess 121 a of the first holder unit 121. The first holder unit 121 contacts an outer surface of the first end of the first receiving recess 121 a to connect or fix the lamp body 111 with the first holder unit 120.

The first electrode 112 of the lamp body 111 is inserted into the first engaging recess 122a of the socket portion 122, and the first coupling jaw 112a of the first electrode 112 couples with the first coupling protrusion 122c of the first engaging recess 122a. Thus, the first electrode 112 may be electrically connected with the socket portion 122.

The first socket 142 coupled to the end of the first wire 141 is received in the third receiving recess 123a of the second holder unit 123. The first protrusion 142d and the second protrusion 142e of the first socket 142 contact each other while passing through the third receiving recess 123a. After passing through the third receiving recess 123a, the first socket 142 is inserted into the second engaging recess 122b. When the first socket 142 is completely inserted into the second engaging recess 122b, the first and second protrusions 142d and 142e are spaced apart from each other by the space 142c.

The third coupling jaw 142f and the fourth coupling jaw 142g of the first socket 142 are coupled with the second coupling protrusion 122d and the third coupling protrusion 122f formed inside the second engaging recess 122b, respectively. Thus, the first wire unit 140 may be fixed or attached with the first holder unit 120. Further, the first driving voltage may be applied to the first electrode 112 of the lamp unit 110 after passing through the first wire unit 140 and the first holder unit 120 because the first socket 142 and the socket portion 122 are electrically connected with each other.

As described above, when the socket portion 122 is applied inside the first holder unit 120, the soldering process for electrically connecting the first electrode 112 of the lamp unit 110 with the insulated conductor wire 141 a of the first wire unit 140 may be omitted. Thus, assembling processes for the lamp assembly 100 may be simplified and defects caused by the soldering process may be prevented, thereby improving yield of manufacturing of the lamp assembly.

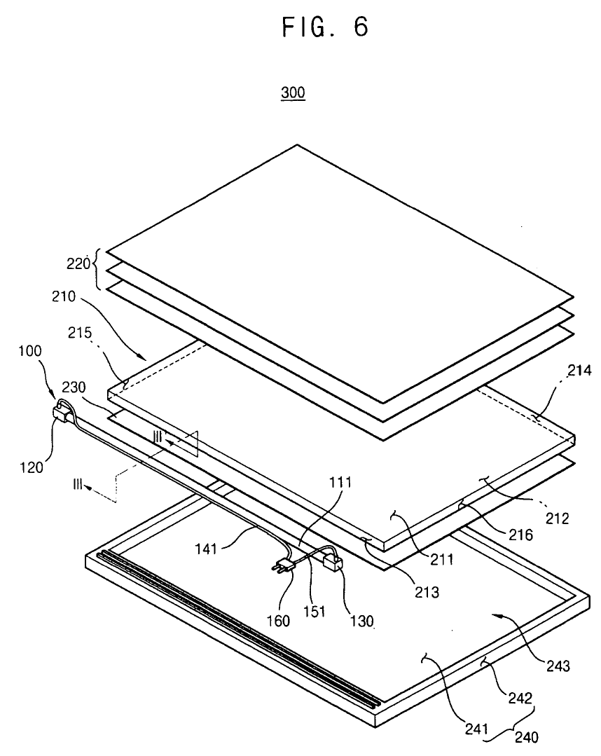

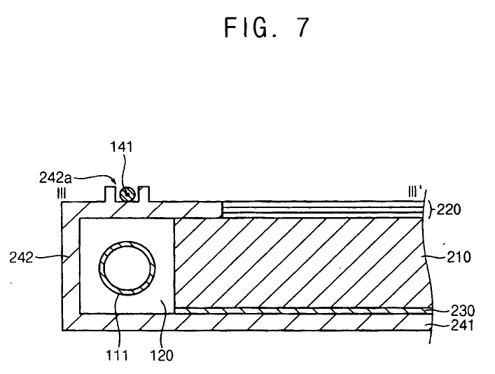

FIG. 6 is an exploded perspective view showing a backlight assembly according to an exemplary embodiment of the invention. FIG. 7 is a cross-sectional view taken along a line III-III′ showing the backlight assembly in FIG. 6. In FIG. 6 and FIG. 7, the same reference numerals are used to denote the same elements in FIG. 1, and any further descriptions of the same elements will be omitted for purposes of convenience.

Referring to FIG. 6 and FIG. 7, a backlight assembly 300 includes the lamp assembly 100, a light guide plate 210, an optical sheet 220, a reflecting sheet 230 and a mold frame 240. 100511 The first wire 141 of the lamp assembly 100 is withdrawn from the first holder unit 120 and returned toward the second holder unit 130. The first driving voltage is applied to the first wire 141 and the second driving voltage having a higher voltage level than the first driving voltage is applied to the second wire 151. Thus, the first wire 141 is returned toward the second holder unit 130 such that the first wire 141 and the second wire 151 may be coupled via a connector 160.

The light guide plate 210 may have a rectangular plate-like shape of which a front face 211, a rear face, a first side face 213, a second side face 214, a third side face 215 and a sixth side face 216 are combined together. The light guide plate 210 receives the light from the lamp assembly 100 through the first side face 213 adjacent to the lamp assembly 100. The light incident into the light guide plate 210 through the first side face 213 is emitted through the front face 211 of the light guide plate 210.

Although not shown in FIG. 6 and FIG. 7, the lamp assembly 100 may further include a lamp cover that receives the lamp 110. The lamp cover is formed of a material having high reflectance to reflect the light from the lamp 110 to the light guide plate 210.

The optical sheet 220 is disposed on the front face 211 of the light guide plate 210. The optical sheet 220 improves brightness and visual angle of the light from the front face 211.

The reflecting plate 230 is disposed under the rear face 212 of the light guide plate 210. The reflecting plate 230 reflects the light that leaks through the rear face 212 of the light guide plate towards the front face 211 to improve light efficiency of the backlight assembly 300.

The mold frame 240 includes a bottom 241 and a sidewall 242 extended from the bottom 241 to provide a receiving space 243 therein. The lamp assembly 100, the reflecting plate 230, the light guide plate 210 and the optical sheet 220 may be sequentially received into the receiving space 243 of the mold frame 240.

The mold frame 240 may include a receiving groove 242a formed on the sidewall 242 adjacent to the lamp assembly 100. The receiving groove 242a receives the first wire 141 returned to the second holder unit 130. When the first wire 141 is returned to the second holder unit 130 while being received in the receiving groove 242a, the backlight assembly 300 may be more easily assembled.

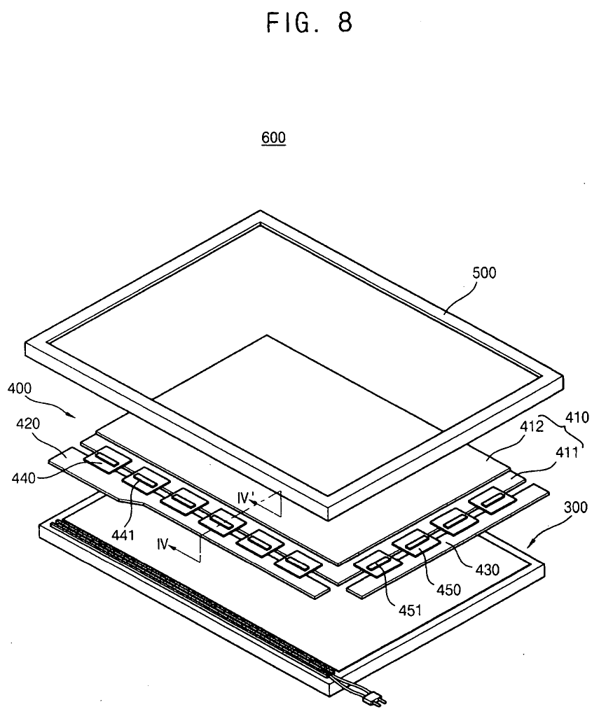

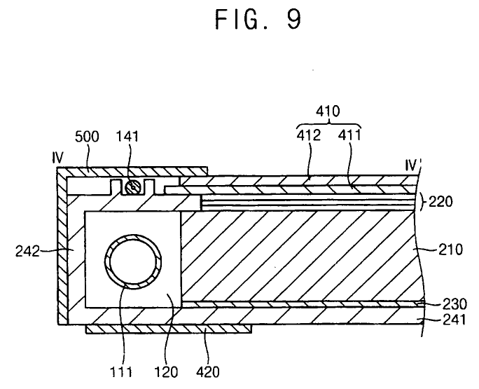

FIG. 8 is an exploded perspective view showing a liquid crystal display apparatus according to an embodiment of the invention. FIG. 9 is a cross-sectional view taken along a lint IV-IV′ showing the liquid crystal display apparatus in FIG. 8.

Referring to FIG. 8 and FIG. 9, a display apparatus 800 includes the backlight assembly 300, a display unit 400, and a top chassis 500.

The display unit 400 includes a liquid crystal display panel 410, a data printed circuit board 420, a gate printed circuit board 430, a data flexible printed circuit film 440 and a gate flexible printed circuit film 450. The data PCB 420 and the gate PCB 430 are electrically connected with the liquid crystal display panel 410 via the data flexible PCB 440 and the gate flexible PCB 450, respectively. The data flexible PCB 440 and the gate flexible PCB 450 include data driving chips 441 and gate driving chips 451, respectively, to convert various signals from the data PCB 420 and the gate PCB 430 into driving signals for the liquid crystal display panel 410.

The liquid crystal display panel 410 includes a thin film transistor (TFT) substrate 411, a color filter substrate 412 facing the TFT substrate 411, and a liquid crystal layer (not shown) interposed between the TFT substrate 411 and the color filter substrate 412.

The TFT substrate 411 may be a transparent glass substrate on which TFTs (not shown) are formed in a matrix-like configuration. Each of the TFTs includes a source terminal connected with a data line, a gate terminal connected with a gate line, and a drain terminal connected with a pixel electrode (not shown) that includes a transparent conductive material.

The color filter substrate 412 includes, for example, red, green and blue color pixels (not shown) and a common electrode (not shown) that also includes a transparent conductive material.

The top chassis 500 is coupled with the mold frame 200 of the backlight assembly 300 while covering an end or perimeter of the liquid crystal display panel 410 such that the liquid crystal display panel 410 is fixed or attached with the mold frame 200. The top chassis 500 prevents damage to the liquid crystal display panel 410 caused by an external impact and also prevents the liquid crystal display panel 410 from separating from the backlight assembly 300.

According to the lamp assembly, the backlight assembly, and the liquid crystal display apparatus discussed above in the non-limiting embodiments of the invention, the socket portion is formed inside the holder unit, thereby omitting the soldering process for electrically connecting the electrode of the lamp unit and the insulated conductor wire of the wire unit.

Therefore, according to the present invention, the assembling processes for the lamp assembly is simplified and defects caused by the soldering process are prevented. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A lamp assembly, comprising:
a wire unit to output a driving signal;
a lamp unit to emit a light in response to the driving signal; and
a holder unit comprising a holder portion and a socket portion,
wherein the holder portion is coupled with the lamp unit and the wire unit, and
wherein the socket portion electrically couples the lamp unit with the wire unit.

2. The lamp assembly of claim 1, wherein the lamp unit comprises:
a lamp body emitting the light; and
an electrode extending from an end portion of the lamp body.

3. The lamp assembly of claim 2, wherein the holder portion comprises a first receiving recess to receive the end portion of the lamp body, and
wherein the socket portion comprises a first engaging recess to engage the electrode.

4. The lamp assembly of claim 3, wherein the electrode comprises a first coupling jaw, and
wherein the socket portion comprises a first coupling protrusion coupled with the first coupling jaw, the first coupling protrusion extending from an inner face of the first engaging recess.

5. The lamp assembly of claim 1, wherein the wire unit comprises:
a wire receiving the driving signal; and
a socket, which is coupled with an end of the wire to attach the wire with the holder unit.

6. The lamp assembly of claim 5, wherein the wire comprises:
an insulated conductor wire comprising a conductive material to receive the driving signal; and
a coating provided on the insulated conductive wire and comprising an insulating material.

7. The lamp assembly of claim 6, wherein the socket comprises:
a receiving portion to receive the end of the wire such that the receiving portion is electrically connected to the insulated conductor wire; and
a protruding portion protruding from the receiving portion of the socket and comprising a first protrusion and a second protrusion spaced apart from each other and facing each other.

8. The lamp assembly of claim 7, wherein the holder portion comprises a second receiving recess to receive the end of the wire, and
wherein the socket portion has a second engaging recess to be engaged with the socket.

9. The lamp-assembly of claim 8, wherein the protruding portion comprises a second coupling jaw, and
wherein the socket portion comprises a second coupling protrusion coupled with the second coupling jaw, the second coupling protrusion extending from an inner face of the second engaging recess.

10. The lamp assembly of claim 1, wherein the socket portion comprises a conductive material.

11. The lamp assembly of claim 1, wherein the socket portion and the holder portion are formed together by an injection molding such that the socket portion is in the holder portion.

12. A lamp assembly, comprising:
a first wire unit comprising a first wire to receive a first driving signal and a first socket coupled with an end of the first wire to receive the first driving signal;
a second wire unit comprising a second wire, which receives a second driving signal, and a second socket coupled with an end of the second wire to receive the second driving signal;
a lamp unit comprising a lamp body, a first electrode connected with a first end of the lamp body to receive the first driving signal, and a second electrode connected with a second end of the lamp body to receive the second driving signal;
a first holder unit comprising a first holder portion coupled with the first end of the lamp body, a second holder portion coupled with an end of the first wire and integrally formed with the first holder portion, and a first socket portion electrically connecting the first wire with the first socket to apply the first driving signal to the first socket; and
a second holder unit having a third holder portion coupled with the second end of the lamp body, a fourth holder portion coupled with an end of the second wire and integrally formed with the third holder portion, and a second socket portion electrically connecting the second wire with the second socket to apply the second driving signal wire to the second socket.

13. The lamp assembly of claim 12, wherein the first socket portion and the second socket portion comprise a conductive material.

14. A backlight assembly, comprising:
a lamp assembly to generate a light in response to a driving signal;
a light guide plate to receive the light and guide the received light; and
a receiving member to receive the lamp assembly and the light guide plate, wherein the lamp assembly comprises:
a first wire unit to output a first driving signal;
a second wire unit to output a second driving signal;
a lamp unit comprising a lamp body, a first electrode and a second electrode extending from a first end and a second end of the lamp body, respectively, to receive a first driving signal and a second driving signal;
a first holder unit comprising a first holder portion coupled with the first end of the lamp body, a second holder portion coupled to the first wire unit and integrally formed with the first holder portion, and a first socket portion formed in the first holder portion to electrically connect the first electrode with the first wire unit; and
a second holder unit comprising a third holder portion coupled with a second end of the lamp body, a fourth holder portion coupled with the second wire unit and integrally formed with the third holder portion, and a second socket portion formed in the third holder portion to couple the second electrode with the second wire unit.

15. The backlight assembly of claim 14, wherein the first wire unit comprises a first wire, which receives the first driving signal, and a first socket, which is coupled with an end of the first wire to receive the first driving signal from the first wire, and
wherein the second wire unit comprises a second wire, which receives the second driving signal, and a second socket, which is coupled with an end of the second wire to receive the second driving signal from the second wire.

16. The backlight assembly of claim 15, wherein the first socket portion comprises a conductive material to electrically connect the first wire with the first socket, and
wherein the second socket portion comprises the conductive material to electrically connect the second wire with the second socket.

17. The backlight assembly of claim 15, wherein the receiving member receives the lamp assembly and the light guide plate.

18. The backlight assembly of claim 17, wherein the first wire is extended toward the second holder unit, and the receiving member comprises a receiving groove to receive the extended first wire.

19. A display apparatus, comprising:
a backlight assembly to generate a light;
a display panel to display an image using the light, wherein the backlight assembly comprises:
a lamp assembly to generate a light in response to a driving signal;
a light guide plate to receive the light and guide the received light; and
a receiving member to receive the lamp assembly and the light guide plate, the lamp assembly comprises:
a first wire unit to output a first driving signal;
a second wire unit to output a second driving signal;
a lamp unit having a lamp body, a first electrode and a second electrode extending from a first end and a second end of the lamp body, respectively, to receive a first driving signal and a second driving signal;
a first holder unit having a first holder portion coupled with a first end of the lamp body, a second holder portion coupled with the first wire unit and integrally formed with the first holder portion, and a first socket portion formed in the first holder portion to electrically connect the first electrode with the first wire unit; and a second holder unit having a third holder portion coupled with a second end of the lamp body, a fourth holder portion coupled with the second wire unit and integrally formed with the third holder portion, and a second socket portion formed in the third holder portion to electrically connect the second electrode with the second wire unit.

20. The display apparatus of claim 19, wherein the first wire unit comprises a first wire, which receives the first driving signal, and a first socket, which is coupled with an end of the first wire to receive the first driving signal from the first wire, and
wherein the second wire unit comprises a second wire, which receives the second driving signal, and a second socket, which is coupled with an end of the second wire to receive the second driving signal.

21. The display apparatus of claim 20, wherein the first socket portion comprises a conductive material to electrically connect the first wire with the first socket, and
wherein the second socket portion comprises the conductive material to electrically connect the second wire and the second socket.

22. The display apparatus of claim 19, further comprising a top chassis coupled to the receiving member to attach the display panel with the receiving member.
